(19) United States
(12) Patent Application Publication
(10) Pub. No.: US 2025/0123916 A1
(43) Pub. Date: Apr. 17, 2025

(54) METHOD FOR DETERMINING AN ANOMALY IN A COMMUNICATION CHANNEL

(71) Applicant: Robert Bosch GmbH, Stuttgart (DE)

(72) Inventors: Michael Andreas Gerlach, Marbach A.N. (DE); Vedant Pramod Paithankar, München (DE)

(21) Appl. No.: 18/904,485

(22) Filed: Oct. 2, 2024

(30) Foreign Application Priority Data
Oct. 12, 2023 (DE) 10 2023 210 037.1

(51) Int. Cl. G06F 11/07; G06F 11/30; G06F 11/34

(52) U.S. Cl. CPC G06F 11/0751; G06F 11/3006; G06F 11/3409

(57) ABSTRACT

A method for determining whether in a communication channel within at least one multicore processor or multicore microcontroller, particularly within a vehicle, an anomaly is present. The at least one multicore processor or multicore microcontroller includes a plurality of cores. A communication between at least two of the plurality of cores is monitored, and based on a monitoring result, it is decided whether the anomaly is present or not.

### FIELD

The present invention relates to a method for determining an anomaly in a communication channel. Furthermore, the present invention relates to a computer program, a data processing apparatus, a multicore processor or multicore microcontroller, and a storage medium for this purpose.

### BACKGROUND INFORMATION

An Intrusion Detection System (IDS) can be integrated into Gateways or other ECUs to monitor the network traffic e.g., on CAN buses. The IDS detects anomalies in CAN data traffic by comparing it with the specified behaviour. So-called Host-based Intrusion Detection Systems, which monitor the characteristics of a single host and the events occurring within that host for suspicious activity, are described in the related art.

European Patent No. EP 2433457 B1 describes a security system for vehicles for vehicles and methods for intrusion detection and measures to react in the event that a cyber attack is detected.

### SUMMARY

According to aspects of the present invention, a method for determining whether in a communication channel within at least one multicore processor or multicore microcontroller, particularly within a vehicle, an anomaly is present, is provided. The at least one multicore processor or multicore microcontroller comprises a plurality of cores. According to present invention, a communication between at least two of the plurality of cores is monitored, and, based on a monitoring result, it is decided whether the anomaly is present or not.

The expression “determining” may be understood as a process of making a decision or determination based on certain criteria or factors. In this context, the expression “determining whether an anomaly is present” refers to a process of monitoring a communication channel within a multicore processor or microcontroller, particularly within a vehicle, and analyzing the communication to determine whether any irregularities or abnormalities are present.

The determination may be made based on various factors, such as the monitoring result of the communication, which may be analyzed to detect any deviations or inconsistencies that may indicate the presence of an anomaly. The determination may also be made based on predefined or definable rules, which may be used to identify specific patterns or characteristics that are indicative of an anomaly.

In summary, the expression “determining” in this context refers to a process of making a decision or determination based on analysis of a communication channel, with the goal of identifying any irregularities or abnormalities that may be present.

The expression “whether” may be understood as a subordinating conjunction that introduces a dependent clause, which provides an alternative condition or situation. In this context, the expression “whether” is used to indicate that the anomaly in the communication channel may be present or not, depending on the monitoring result.

For example, the expression “whether” is used to introduce a dependent clause that states that the anomaly is present or not, depending on the monitoring result. The dependent clause provides an alternative condition or situation that may occur in the communication channel, and the expression “whether” allows the patent applicant to specify that either condition may be true.

Similarly, the expression “whether” is used to introduce a dependent clause that states that the decision whether the anomaly is present or not is based on a, particularly predefined or definable, set of rules. The dependent clause provides an alternative condition or situation that may occur in the communication channel, and the expression “whether” allows the patent applicant to specify that either condition may be true.

Overall, the expression “whether” is used in the patent claims to provide an alternative condition or situation that may occur in the communication channel, and to indicate that the anomaly in the communication channel may be present or not, depending on the monitoring result.

The expression “anomaly” may be understood as an irregularity or deviation from what is expected or usual. In the context of the present invention, an anomaly refers to any abnormality or irregularity detected in the communication channel within the multicore processor or microcontroller. This could include anything from a simple error in the data being transmitted to a more serious security breach or attack on the system. The detection of an anomaly is critical to the functioning of the present invention, as it allows the system to take appropriate action to address the issue and prevent further problems.

It is important to note that the term “anomaly” does not imply a specific type or level of severity. Rather, it is a general term that encompasses a wide range of potential issues that may arise in the communication channel. The specific criteria for identifying an anomaly will depend on the particular application and the requirements of the system. In general, however, an anomaly will be defined as any deviation from the expected or normal behavior of the system that is significant enough to require attention or action.

The expression “channel” may be understood as a communication path or medium through which data, information, or signals are transmitted between two or more entities, such as devices, systems, or components. In the context of the present invention, the channel refers to the communication path or medium within the at least one multicore processor or multicore microcontroller, particularly within a vehicle, through which data is transmitted between at least two of the plurality of cores.

The channel may be a physical or virtual medium, such as a wired or wireless communication link, a network interface, a memory bus, or a communication protocol. The channel may also be a logical or virtual entity, such as a data stream, a message queue, or a file system.

The channel may be used to transmit a wide range of data, including control signals, data packets, messages, or files. The channel may also be used to transmit data in real-time or in batches, depending on the requirements of the system or application.

In summary, the expression “channel” in the present invention refers to the communication path or medium through which data is transmitted between at least two of the plurality of cores within the at least one multicore processor or multicore microcontroller, particularly within a vehicle.

The expression “multicore” may be understood as a type of processor or microcontroller that contains multiple processing cores within a single chip or package. These processing cores are capable of executing multiple instructions simultaneously, which can lead to significant performance improvements over traditional single-core processors. In this context, the term “multicore processor or multicore microcontroller” refers to a device that contains multiple processing cores and is used to monitor a communication channel within a vehicle for the presence of an anomaly.

The expression “processor” may be understood as a device or a system that performs processing or computations on data or information. In this context, the term “processor” is used to refer to a multicore processor or multicore microcontroller, which is a device that comprises multiple processing cores and is capable of executing multiple tasks or instructions simultaneously. The processor is particularly useful in a vehicle, where it can be used to control various systems and functions, such as engine management, transmission control, and safety features.

The processor can be configured to monitor a communication channel within the vehicle, which may include a communication between different components or systems of the vehicle. The processor can detect and analyze any anomalies or errors in the communication channel, and based on the monitoring result, it can decide whether an anomaly is present or not.

In addition to the above-mentioned functions, the processor may also be configured to perform other tasks or functions, such as data processing, calculation, and storage. The processor may also be connected to other devices or systems, such as sensors, actuators, and other processors, which can further enhance its capabilities and functionality.

Overall, the expression “processor” is used here to refer to a device or system that is capable of processing and analyzing data or information, and monitoring a communication channel within a vehicle. The processor is a key component of the present invention, and its specific configuration and functionality will depend on the particular implementation and application of the present invention.

The expression “microcontroller” may be understood as a computer processor that is capable of executing instructions and is integrated into a single chip. A microcontroller is typically smaller and more compact than a microprocessor, and it often includes built-in memory, input/output (I/O) interfaces, and other peripherals. Microcontrollers are often used in embedded systems, such as those found in household appliances, automotive systems, and other devices that require programmable control.

In the context of the present invention, a microcontroller is used as part of a multicore processor or multicore microcontroller, which is a device that contains two or more processing cores. The multicore processor or microcontroller is used to monitor a communication channel within the vehicle, and it is capable of detecting anomalies in the communication. The microcontroller is programmed with instructions that allow it to monitor the communication and make decisions based on the monitoring results.

It is worth noting that the term “microcontroller” is often used interchangeably with the term “single-chip microcomputer.” However, some sources distinguish between the two terms, with “microcontroller” being used to refer specifically to a microprocessor that is integrated with other electronic components, such as memory, I/O interfaces, and peripherals, while “single-chip microcomputer” is used to refer to a microprocessor that is not integrated with other components. In the context of the present invention, the term “microcontroller” is used to refer to a device that combines a microprocessor with other electronic components, regardless of whether the term “microcontroller” or “single-chip microcomputer” is used.

The expression “vehicle” may be understood as a self-propelled motor vehicle, such as a car, a truck, a bus, a motorcycle, a bicycle, a boat, an aircraft, a spacecraft, or any other type of vehicle that is designed to transport people or goods from one place to another.

More specifically, the term “vehicle” can include any type of vehicle that is driven by a human operator, such as a car, a truck, or a bus, or any type of vehicle that is driven by a computer or an autonomous system, such as a self-driving car or a drone.

In the context of the present invention, the term “vehicle” can also include any type of vehicle that is used for a specific purpose, such as an ambulance, a fire truck, a police car, or a delivery van.

The expression “cores” may be understood as the processing units or processing elements within a multicore processor or multicore microcontroller. In the context of the present invention, the term “cores” refers to the individual processing units or processing elements that are integrated within a single chip or package. These processing units or processing elements are capable of executing instructions independently and may be connected to each other via a shared memory or bus.

Each core typically has its own set of registers, program counter, and other basic components that are required for execution of instructions. The cores may be designed to operate independently or in conjunction with other cores within the same processor or microcontroller.

In the context of the present invention, the term “cores” is used to refer to the individual processing units or processing elements within a multicore processor or multicore microcontroller. The present invention relates to a method for detecting anomalies in a communication channel between at least two of the plurality of cores within the multicore processor or multicore microcontroller.

The expression plurality may be understood as a group of two or more items. It is used here to refer to the fact that the multicore processor or multicore microcontroller comprises a plurality of cores. This means that the device has more than one cores.

The expression “monitored” may be understood as the act of observing, tracking, or examining the communication between at least two of the plurality of cores in order to detect any potential anomalies or irregularities. This monitoring may involve the collection and analysis of data related to the communication, such as the data being sent between the cores, the timing of the communication, or any other relevant information. The monitoring may also involve the use of various techniques, such as cryptographic checksums or other security mechanisms, to ensure the integrity and security of the communication. The monitoring may be performed by a dedicated monitoring system or by the cores themselves, and the results may be used to make decisions about the communication, such as whether to allow the communication to continue or to stop it if an anomaly is detected.

The expression “monitoring” may be understood as the act of observing or keeping track of a specific aspect or characteristic of a system, process, or communication channel. In the context of the present invention, monitoring refers to the act of observing or keeping track of the communication between at least two cores of a multicore processor or multicore microcontroller, particularly within a vehicle.

More specifically, monitoring involves tracking the communication between the at least two cores, analyzing the communication, and determining whether any anomalies are present. This may involve monitoring the communication in real-time, or analyzing the communication after it has been completed.

According to the present invention, the monitoring may be performed using various techniques, such as:
Monitoring the data being sent between the at least two cores, such as the data format, data length, and cyclic check sum value (CRC).
Monitoring the communication protocol used by the at least two cores, such as the start of frame (SOF), data length (DL), data (DATA), and end of frame (EOF).
Monitoring the communication for any tampering, such as buffer overflows, port scanning attacks, or invalid remote processor authentications.
Monitoring the communication for any errors or inconsistencies, such as checking the cyclic check sum value (CRC) of the data being sent.

Overall, the expression “monitoring” in the present invention refers to the act of observing and analyzing the communication between at least two cores of a multicore processor or multicore microcontroller, particularly within a vehicle, in order to detect any anomalies that may indicate a security threat.

The expression “result” may be understood as the outcome or consequence of a process or action. In the context of the method according to the present invention, the result refers to the outcome of monitoring the communication between at least two of the plurality of cores within the at least one multicore processor or multicore microcontroller. This monitoring process may involve various techniques, such as checking for tampering, buffer overflows, port scanning attacks, or invalid remote processor authentications, as described further below.

Based on the monitoring result, the method determines whether an anomaly is present in the communication channel. The method may use a predefined or definable set of rules to determine whether the anomaly is present or not.

In summary, the term “result” refers to the outcome of monitoring the communication between the plurality of cores, and the method uses this outcome to determine whether an anomaly is present in the communication channel.

The expression “decided” may be understood as a determination or a conclusion that is reached based on the monitoring result. In the context of the present invention, the decision is made by the at least one multicore processor or multicore microcontroller, particularly within a vehicle, after monitoring the communication between at least two of the plurality of cores. The decision is made based on the monitoring result, which indicates whether an anomaly is present or not.

The decision is a binary one, meaning that it can only be one of two options: either the anomaly is present, or it is not. The decision is made after evaluating the monitoring result and determining whether it satisfies the predefined or definable set of rules. If the monitoring result satisfies the set of rules, the decision is that the anomaly is present, otherwise, the decision is that the anomaly is not present.

According to the present invention, it may be advantageous if the monitoring of the communication comprises at least one of the following:
monitoring, if at least one frame of the data being sent between the at least two of the plurality of cores was tampered;
monitoring, if a buffer overflow is present;
monitoring, if a port scanning attack is present;
monitoring, if an invalid remote processor authentication is present;
monitoring, if the data being sent between the at least two of the plurality of cores was modified, particularly by checking a cyclic check sum value (CRC).

The expression “frame” may be understood as a logical and temporal grouping of data units within a communication channel. A frame is a sequence of data units that is transmitted between two or more devices within a communication channel. The frame is the basic unit of data transmission in a communication channel, and it is used to organize and structure the data being transmitted.

In the context of the present invention, a frame is typically used to refer to a group of data units that are transmitted between two or more cores within a multicore processor or microcontroller. Each frame may contain a predefined or definable format, which includes a start of frame (SOF), a data length (DL), data (DATA), a cyclic check sum value (CRC), and/or an end of frame (EOF). The data within a frame may be encrypted before sending by a first core and decrypted after receiving by a second core.

The monitoring of the communication may include monitoring the integrity of the data within a frame, such as checking the cyclic check sum value (CRC) to ensure that the data has not been modified during transmission. The monitoring of the communication may also include monitoring for buffer overflows, port scanning attacks, and invalid remote processor authentication.

It is to be noted that the term “frame” is a conceptual representation and may be implemented in different ways depending on the specific implementation of the present invention. The description provided above is intended to provide a general understanding of the term “frame” as used in the context of the present invention, and is not limiting the scope of the present invention in any way.

The expression tampered may be understood as a state of modification or alteration of the data being sent between the at least two of the plurality of cores, such that the data is no longer in its original or intended format. This could include modifications made to the data by an unauthorized party, or changes made to the data as a result of a malfunction or error. In this context, the monitoring of the communication is carried out to detect whether any tampering has occurred, and to determine whether an anomaly is present or not.

The expression “buffer overflow” may be understood as a situation where a data processing system is unable to receive or store data because the buffer, which is a temporary storage area for data, is full and cannot accept any more data. This situation occurs when the data being received or sent exceeds the capacity of the buffer, causing the system to overwrite the existing data in the buffer.

In this context, the term “buffer overflow” may refer to a situation where the communication between two or more cores in a multicore processor or microcontroller is tampered with or modified, resulting in the buffer being overfilled and unable to process the data correctly. This may occur due to various reasons such as a malicious attack, a software bug, or a hardware failure.

To mitigate the risk of buffer overflows, the system may implement various security measures such as encryption, authentication, and error detection and correction. These measures can help to ensure that the data being transmitted between the cores is secure and reliable, and that any attempts to tamper with the data are detected and prevented.

The expression “port scanning attack” may be understood as a type of cyber attack where an attacker attempts to identify open ports on a computer system or network in order to gain unauthorized access to the system or to exploit vulnerabilities in the open ports.

In this context, the port scanning attack is being referred to as a potential anomaly that may be detected and monitored within a communication channel between at least two cores of a multicore processor or microcontroller, particularly within a vehicle.

To better understand this convept, it may be helpful to consider the following:
A port is a numbered endpoint in a computer network that allows communication between a process or an application and the network.
When a system is connected to a network, it is assigned a set of open ports that are used to communicate with other systems on the network.
An attacker may use a port scanning tool to scan a range of IP addresses and identify the open ports on each system in order to gain unauthorized access to the system or to exploit vulnerabilities in the open ports.

In this context, the port scanning attack may be detected and monitored by monitoring the communication between the at least two cores of the multicore processor or microcontroller, and identifying instances where an attacker is attempting to scan for open ports on the system or network. This may involve monitoring the communication for specific patterns or anomalies that indicate a port scanning attack is occurring.

It is important to note that the specific implementation of the port scanning attack detection and monitoring may vary depending on the specific requirements and constraints of the system or application being protected. However, in general, the approach described above may be used to detect and monitor port scanning attacks in a communication channel between at least two cores of a multicore processor or microcontroller, particularly within a vehicle.

The expression “invalid remote processor authentication” may be understood as a situation where a remote processor or microcontroller is attempting to access or communicate with a different remote processor or microcontroller, but the communication is not authorized due to a lack of proper authentication or authorization. This could occur in a variety of ways, such as if a remote processor or microcontroller is attempting to access a system or network without proper credentials or permissions, or if a remote processor or microcontroller is attempting to access a system or network using a fake or stolen identity.

In this context, the expression “invalid remote processor authentication” may be used to describe a situation where a plurality of cores within a multicore processor or multicore microcontroller is attempting to communicate with each other, but the communication is not authorized due to a lack of proper authentication or authorization. This could occur if one of the plurality of cores is attempting to access or communicate with another core without proper credentials or permissions, or if a core is attempting to access or communicate with another core using a fake or stolen identity.

It is important to note that the expression “invalid remote processor authentication” is not limited to the described scenario, and may be used in other contexts where a remote processor or microcontroller is attempting to access or communicate with a different remote processor or microcontroller without proper authorization.

The expression “modified” may be understood as a change made to the data being sent between the at least two of the plurality of cores, particularly by checking a cyclic check sum value. This change can be made intentionally or unintentionally, and it can be done by any entity involved in the communication, including the sender, the receiver, or a third party. The modification can be subtle, such as changing a single bit in the data, or it can be more significant, such as altering the entire content of the data.

The modification can be detected by comparing the data being sent with a known or expected value, such as a checksum or a set of rules. If the data being sent does not match the expected value, it can be considered modified. The modification can be used to detect tampering or malicious activity in the communication, and it can also be used to ensure the integrity of the data being sent.

It is important to note that the expression “modified” is not limited to the changes made to the data itself, but it can also refer to changes made to the communication protocol or the communication process. For example, if the communication protocol is modified, it can affect the way the data is sent and received, and it can introduce new vulnerabilities or security risks. Similarly, if the communication process is modified, it can affect the timing or the sequence of the communication, and it can also introduce new vulnerabilities or security risks.

The expression “cyclic check sum value” may be understood as a mathematical calculation that is performed on a set of data in order to verify its integrity and authenticity. More specifically, a cyclic check sum value is a numerical value that is calculated by applying a specific algorithm to the data, which is then compared to a predetermined value to determine whether the data has been tampered with or not.

In the context of the present invention, the cyclic check sum value is used to verify the integrity of the data being sent between the at least two of the plurality of cores. The algorithm used to calculate the cyclic check sum value is typically a cryptographic hash function, such as a cyclic redundancy check (CRC) or a secure hash algorithm (SHA). The specific algorithm used will depend on the requirements of the system and the type of data being transmitted.

To calculate the cyclic check sum value, the data being sent is first divided into a series of fixed-length blocks. Each block is then processed by the hash function, which generates a fixed-length output that is unique to the input data. The outputs from each block are then combined to generate a single cyclic check sum value.

When the data is received, the same algorithm is applied to the data to generate a new cyclic check sum value. The two values are then compared to determine whether the data has been tampered with or not. If the values match, then the data is considered to be authentic and has not been tampered with. If the values do not match, then the data has been tampered with and the communication should be stopped.

In summary, the cyclic check sum value is a mathematical calculation that is used to verify the integrity of data being transmitted between the at least two of the plurality of cores. It is a cryptographic hash function that is applied to the data being transmitted to generate a unique value that can be used to determine whether the data has been tampered with or not.

According to an aspect of the present invention, the decision whether the anomaly is present or not is based on a, particularly predefined or definable, set of rules.

The expression “decision” may be understood as the result of a process or evaluation that determines the outcome or conclusion of an event or situation. In this context, the decision whether an anomaly is present or not is based on a set of rules, which are predefined or definable. The rules may be based on various criteria, such as the monitoring result, the type of anomaly, or other relevant factors. The decision is the output of the process, which indicates whether an anomaly is present or not.

It is a binary outcome that is determined based on the evaluation of the monitoring result and the rules.

The expression “particularly predefined or definable set of rules” may be understood as a set of guidelines that are predefined or can be defined by the user or system. The set of rules are used to determine whether an anomaly is present in a communication channel within a multicore processor or microcontroller, particularly within a vehicle. The rules are predefined or can be defined by the user or system, and they are used to analyze the data being sent between the plurality of cores and to determine whether any anomalies are present. The set of rules are particular in that they are defined by the user or system, and they are used to define the specific criteria for determining whether an anomaly is present in the communication channel.

According to another aspect of the present invention, the communication between the at least two of the plurality of cores is based on data being sent between the at least two of the plurality of cores, wherein the data comprises a predefined or definable format.

The expression “between the at least two of the plurality of cores” refers to the communication that takes place between at least two of the plurality of cores in a multicore processor or multicore microcontroller. This communication is typically initiated by one of the cores and is intended to be received by another core. The data being sent between the cores is specified to comprise a predefined or definable format, which may include a start of frame (SOF), a data length (DL), data (DATA), a cyclic checksum value (CRC) and/or an end of frame (EOF). The communication may be encrypted before sending by a first core and decrypted after receiving by a second core. The data integrity may also be monitored after transmission of the data using a cryptographic checksum over the payload of the data being sent between the at least two of the plurality of cores.

The expression “data” may be understood as any information that is transmitted between the at least two of the plurality of cores in the communication channel. More specifically, the data may be in a predefined or definable format, and may include a start of frame (SOF), a data length (DL), actual data (DATA), a cyclic check sum value (CRC), and/or an end of frame (EOF). The data may also be encrypted before sending by a first of the at least two of the plurality of cores and decrypted after receiving by a second of the at least two of the plurality of cores. Additionally, a cryptographic checksum may be used to monitor data integrity after transmission of the data. The data may also be stored in a log file and/or outputted as a warning signal to a user, and the communication may be stopped if an anomaly is present.

The expression “sent between the at least two of the plurality of cores” may be understood as referring to the transmission of data between two or more of the plurality of cores within a multicore processor or multicore microcontroller. In other words, the data is transmitted from one core to another core, and not directly to the outside of the processor or microcontroller.

The plurality of cores within the multicore processor or multicore microcontroller may be of different types, such as processing cores, memory management cores, or input/output cores. The data being sent between the plurality of cores may be in the form of packets, frames, or other data structures, and may be transmitted using a variety of communication protocols, such as Ethernet, Wi-Fi, or cellular network protocols.

It is important to note that the expression “sent between the at least two of the plurality of cores” does not necessarily imply a direct communication path between the two cores. The data may be transmitted through a shared memory or a communication bus, or it may be transmitted through a series of intermediary cores or devices.

In this context, the expression “sent between the at least two of the plurality of cores” is used to describe the communication between the cores within the multicore processor or multicore microcontroller, and is not intended to imply a specific communication protocol or path.

The expression “predefined or definable format” may be understood as a format of data that is explicitly or implicitly specified or agreed upon between the entities involved in the communication. This format can be predefined, meaning that it is established beforehand and is fixed, or it can be definable, meaning that it can be defined or modified later on.

In this context, the predefined or definable format of the data being sent between the plurality of cores refers to a format that has been established or agreed upon between the cores, or one that can be defined or modified later on. This format can include the structure, layout, and organization of the data, as well as any specific rules or constraints that must be followed in order to ensure compatibility and consistency between the data being sent between the cores.

For example, the predefined or definable format could specify that the data must be sent in a specific order, or that certain fields must be included or excluded. It could also specify the types of data that are allowed, such as integers, strings, or floating-point numbers, or the maximum or minimum values that can be represented by each type of data.

Overall, the predefined or definable format is an important aspect of the communication between the plurality of cores, as it ensures that the data being sent between them is structured and organized in a consistent and predictable manner, which allows for efficient and reliable communication.

According to a further aspect of the present invention, the data format comprises a start of frame (SOF), a data length (DL), data (DATA), a cyclic check sum value (CRC) and/or an end of frame (EOF).

The expression “start of frame” may be understood as a sequence of bits or symbols that marks the beginning of a data frame in a communication channel. The frame is the smallest unit of data that can be transmitted over the channel, and it typically contains a header, data payload, and a trailer. The start of frame signal is used to indicate the beginning of a new frame and to separate it from any previous frames that may have been transmitted.

The start of frame signal may take various forms depending on the specific communication protocol being used. In some cases, it may be a fixed sequence of bits that is always the same, while in other cases it may be a variable sequence that is determined dynamically based on the context of the transmission.

In this context, the start of frame signal is used to monitor the communication between the plurality of cores in a multicore processor or microcontroller, and to detect any anomalies or security breaches in the communication. By analyzing the start of frame signal, the present invention can determine whether a frame is valid or not, and take appropriate action if necessary.

It is worth noting that the start of frame signal is just one aspect of the data format used in the communication channel. Other important components of the data format include the data length, data payload, and cyclic check sum value, which are also described.

The expression “data length” may be understood as the number of bytes or bits of data that are being transmitted between the cores of the multicore processor or microcontroller. This number can be determined by analyzing the format of the data being transmitted, which is typically specified in the communication protocol used by the cores. For example, if the data being transmitted has a fixed length, such as 16 bytes, then the data length would be 16. If the data has a variable length, then the data length would be determined based on the actual number of bytes of data being transmitted in a particular communication.

It is important to note that the data length is not the same as the payload length, which is the length of the actual data being transmitted, excluding any header or footer information.

The data length includes the payload length, as well as any additional information that may be included in the data packet, such as checksums or error-correction codes.

The expression “end of frame” may be understood as a term used to indicate the end of a data frame within a communication protocol. A data frame is a logical unit of data transmitted between two devices, and it typically includes a header, a payload, and a trailer. The header and trailer are used to indicate the start and end of the frame, respectively. The end of frame is typically indicated by a special symbol or code that is not part of the payload data.

In this context, the expression “end of frame” is used to describe a specific format for the data being sent between the at least two cores within the multicore processor or microcontroller. The format includes a start of frame (SOF), a data length (DL), data (DATA), a cyclic check sum value (CRC), and/or an end of frame (EOF). The end of frame is the last part of the data frame and is typically used to indicate the end of the data payload.

It is important to note that the expression “end of frame” is a technical term used in the field of computer networking and communication protocols, and it may have different meanings depending on the context in which it is used. However, in this context, the expression “end of frame” is used to describe a specific format for the data being sent between the at least two cores within the multicore processor or microcontroller.

According to an aspect of the present invention, the data being sent between the at least two of the plurality of cores is encrypted before sending by a first of the at least two of the plurality of cores and decrypted after receiving by a second of the at least two of the plurality of cores.

In this context, the expression “sending” is used to describe the act of transmitting data between at least two of the plurality of cores within a multicore processor or multicore microcontroller. This can be done through a direct communication between the cores or through the use of a network.

It is important to note that the expression “sending” is used in the context of the present invention to describe the act of transmitting data between at least two of the plurality of cores, and not the act of transmitting data from the multicore processor or multicore microcontroller to an external device.

The expression “encryption” may be understood as a process of converting plaintext into ciphertext, which is unreadable without the use of a decryption key. This process involves the use of cryptographic algorithms and techniques, which ensure that the data being transmitted is secure and cannot be easily intercepted or deciphered by unauthorized parties.

In the context of the present invention, the data being sent between the at least two of the plurality of cores is encrypted before being sent by the first of the at least two of the plurality of cores. This ensures that the data is secure and cannot be easily intercepted or deciphered by unauthorized parties before it is received by the second of the at least two of the plurality of cores.

The encryption process may involve the use of a symmetric-key encryption algorithm, such as AES (Advanced Encryption Standard), or an asymmetric-key encryption algorithm, such as RSA (Rivest-Shamir-Adleman). The encryption process may also involve the use of a secure pseudo-random number generator (PRNG) to generate the encryption key.

The decryption process, which is carried out by the second of the at least two of the plurality of cores, involves the use of the same cryptographic algorithm and key that were used for the encryption process. The decryption process may also involve the use of a secure PRNG to generate the decryption key.

It is to be noted that the encryption and decryption processes are typically asymmetric, meaning that the same key is used for both encryption and decryption, but the processes themselves are different. The encryption process is typically performed by the sender, while the decryption process is typically performed by the receiver.

In summary, the expression “encryption” in the present invention refers to the process of converting plaintext into ciphertext, which is unreadable without the use of a decryption key, in order to ensure the security and confidentiality of data being transmitted between the at least two of the plurality of cores.

It is important to note that the sending of data is a one-way process, meaning that the data is transmitted from one point to another without the possibility of feedback or confirmation of receipt.

The expression “receiving” may be understood as the process of acquiring or accepting data, information, or signals from an external source or medium, such as a sender or transmitter. In this context, the expression “receiving” refers to the act of receiving data that has been encrypted by a first core and transmitted through a communication channel. The receiving core, which is typically a second core, decrypts the received data using a predefined decryption algorithm or key. The decrypted data is then processed or used by the receiving core for further processing or analysis.

It is important to note that the expression “receiving” is a broad term that can encompass a wide range of communication protocols and technologies, including wired and wireless communication systems. In the context of the present invention, the expression “receiving” is used specifically in reference to the communication between the at least two cores within a multicore processor or microcontroller.

The expression “decryption” may be understood as the process of converting ciphertext (encrypted data) back into plaintext (original data) using a decryption key. This process is typically done by a receiving party who has received the encrypted data from a sending party.

In this context, the expression “decryption” refers to the process of converting the encrypted data being sent between the at least two of the plurality of cores back into the original data using a decryption key. This process is typically done by the second of the at least two of the plurality of cores who has received the encrypted data from the first of the at least two of the plurality of cores.

The decryption process typically involves the following steps:
1. The receiving party obtains the encrypted data from the sending party.
2. The receiving party obtains the decryption key from the sending party or from a secure source.
3. The receiving party uses the decryption key to decrypt the encrypted data.
4. The receiving party obtains the plaintext data from the decrypted data.

It is important to note that the decryption process must be done in a secure manner to prevent unauthorized access to the encrypted data. This may involve using secure communication protocols, secure encryption algorithms, and secure key management techniques.

According to another aspect of the present invention, it is advantageous to use a cryptographic checksum over a payload of the data being sent between the at least two of the plurality of cores and monitoring data integrity after transmission of the data.

The expression “Cryptographic checksum” may be understood as a mathematical operation that is applied to a message or data packet and produces a unique, fixed-size value that can be used to verify the integrity of the message or data packet. This checksum is typically used in conjunction with encryption to ensure that the message or data packet has not been tampered with during transmission. The cryptographic checksum is calculated over the payload of the data being sent between the at least two of the plurality of cores and is used to monitor the data integrity after transmission of the data.

The cryptographic checksum is a secure and reliable way to detect any modifications made to the data during transmission. It is used in conjunction with encryption to provide an additional layer of security and to ensure that the data being transmitted is not tampered with. The use of a cryptographic checksum can help to detect and prevent attacks such as tampering, eavesdropping, and replay attacks.

In this context, the use of a cryptographic checksum over the payload of the data being sent between the at least two of the plurality of cores and monitoring data integrity after transmission of the data can be understood as a security feature that is used to ensure the integrity of the data being transmitted. This feature can be used to detect any modifications made to the data during transmission and to prevent the data from being tampered with.

It is worth noting that the cryptographic checksum is a mathematical operation that can be easily implemented and is widely used in various applications. It is a well-established and widely accepted technique that is used in a variety of fields, including cryptography, computer science, and engineering.

The expression “payload” may be understood as the actual data or information being transmitted or communicated between the at least two of the plurality of cores. It refers to the content or message being sent, excluding any headers, footers, or other information that may be added for error-checking or other purposes. In the context of the present invention, the payload may be a specific format, such as a start of frame (SOF), a data length (DL), data (DATA), a cyclic check sum value (CRC) and/or an end of frame (EOF), which is used to ensure data integrity and authenticity.

It is worth noting that the term “payload” is often used in the context of computer networking and data communication, and it is a common term in the field of cryptography. Therefore, it is important to use clear and concise language when describing the expression “payload” in the context of the present invention, in order to avoid any confusion or misunderstanding.

The expression “data integrity” may be understood as the assurance that the data being transmitted or stored is accurate, complete, and unaltered. This means that the data has not been modified or tampered with in any way during transmission or storage, and that it is free from errors or corruptions that could affect its intended use or interpretation.

The use of a cryptographic checksum over the payload of the data being sent between the at least two of the plurality of cores is a way to monitor data integrity after transmission of the data. A cryptographic checksum is a mathematical calculation that is applied to the data in such a way that any changes to the data will result in a different checksum value. By comparing the checksum value calculated over the received data with the expected checksum value, it is possible to determine whether the data has been altered or tampered with during transmission.

In addition to detecting alterations to the data, monitoring data integrity can also involve checking the data for other types of errors or inconsistencies, such as errors in formatting or structure, or inconsistencies in the data itself. By monitoring data integrity in this way, it is possible to ensure that the data being transmitted or stored is reliable and accurate, and that it can be used or interpreted as intended.

The expression “transmission of the data” can be understood as the process of sending the data from one device to another device. This process involves the following steps:
1. The data is stored in a buffer or memory of the sending device.
2. The data is then transmitted from the sending device to the receiving device through a communication channel, such as a network, a bus, or a cable.
3. The data is received by the receiving device and stored in a buffer or memory of the receiving device.

During the transmission of the data, the data may be modified or corrupted due to various reasons such as noise, interference, or errors in the transmission medium. To ensure the integrity of the data, a cryptographic checksum can be used to monitor data integrity after transmission of the data. The cryptographic checksum is a mathematical calculation that is performed on the data before it is transmitted, and then again after it is received. If the checksums match, then the data has not been modified or corrupted during transmission.

According to aspects of the present invention, the anomaly is stored in a log file and/or a warning signal is outputted to a user and/or the communication is stopped if the anomaly is present.

The expression “log file” may be understood as a file that is used to store information about events or transactions that occur in a computer system. This information is typically stored in a structured format, such as a text file or a database table, and may include information such as the date and time of the event, the source of the event, and any relevant details about the event.

Log files are commonly used in a variety of contexts, including system administration, debugging, and security monitoring. For example, a log file might be used to store information about system events such as login attempts, file access, or system crashes. It might also be used to store information about network traffic, such as the source and destination IP addresses of network packets.

In the context of the present invention, a log file may be used to store information about anomalies that are detected in a communication channel within a multicore processor or microcontroller. This information may include the date and time of the anomaly, the nature of the anomaly (e.g., a tampered frame, a buffer overflow, etc.), and any other relevant details.

The use of a log file in this context allows the user to easily review and analyze the anomalies that have been detected, and to take appropriate action to address any security issues that may have arisen. For example, the user may use the information in the log file to identify any patterns or trends in the anomalies, or to determine the source of the anomalies.

The expression “warning signal” may be understood as a signal or message transmitted to a user or system to indicate that an anomaly or potential threat has been detected in the communication between the cores of the multicore processor or microcontroller. This signal may be used to alert the user or system to the potential issue and allow for appropriate action to be taken to address the anomaly. The warning signal may be provided in various forms, such as through a log file, a visual or auditory alert, or a message sent to a remote system or user.

The expression “user” may be understood as the person who is using the method, apparatus, or device described herein. The user may be a driver, passenger, or other person who is using the vehicle equipped with the multicore processor or multicore microcontroller described in the following. The user may also be a person who is using the computer program or data processing apparatus described in the following, respectively.

The expression “stopping” is a term that is commonly used in the field of computer science and communication systems. In this context, the expression “stopping” may be understood as the action of interrupting or disrupting the communication between at least two of the plurality of cores within the multicore processor or multicore microcontroller.

In other words, when the anomaly is present in the communication, the method according to one of the before mentioned examples may be configured to stop the communication between the at least two cores, in order to prevent any further damage or loss of data. This may be achieved by disabling the communication channels or buses that connect the cores, or by shutting down the cores themselves.

In another aspect of the present invention, a computer program may be provided, comprising instructions which, when the computer program is executed by a computer, cause the computer to carry out the method according to the present invention.

The expression “Computer program” may be understood as a set of instructions that are written in a programming language and are executed by a computer. These instructions are used to perform a specific task or set of tasks, and they are typically stored in a computer's memory or on a computer-readable storage medium such as a hard drive, solid-state drive, or digital versatile disc.

A computer program can be thought of as a script or a set of rules that a computer follows to perform a specific task. The program can be executed by a computer in a variety of ways, such as through a command line interface, a graphical user interface, or by being run automatically at a specific time or under specific conditions.

In yet another aspect of the present invention, a data processing apparatus is provided, comprising means for carrying out the method according to the present invention.

The expression “data processing apparatus” may be understood as a device that is specifically designed to process or manipulate data. This can include a wide range of devices, such as computers, smartphones, tablets, and other electronic devices that are capable of processing data.

The data processing apparatus may include various components, such as a central processing unit (CPU), memory, input/output (I/O) devices, and other peripherals. It may also include one or more multicore processors or multicore microcontrollers that are capable of processing data in parallel, as well as other components that are necessary for data processing.

In general, the data processing apparatus is a device that is designed to perform specific tasks related to data processing, and it may be used in a variety of applications, such as in vehicles, industrial control systems, and other electronic systems.

The expression “means” in this context may be understood as a component, a set of components, or a combination of components that are capable of performing the method according to the present invention.

In the context of a data processing apparatus, the means for carrying out the method according to the present invention may include hardware, software, or a combination of both. For example, the means may include one or more processors, one or more memories, one or more input/output interfaces, and/or one or more storage devices.

The means may also include one or more programs, algorithms, or other code that are executable by the processor(s) and/or other components to perform the steps of the method. The means may also include one or more data structures, databases, or other data storage mechanisms that are used to store data or other information used by the method.

In general, the expression “means” is intended to be broad and flexible, and may be implemented in various ways depending on the specific requirements of the system or application.

In another aspect of the present invention, a multicore processor or multicore microcontroller may be provided, particularly within a vehicle, wherein the multicore processor or multicore microcontroller comprises a plurality of cores, wherein the multicore processor or multicore microcontroller is configured to that a communication between at least two of the plurality of cores is monitored, wherein based on a monitoring result, it is decided whether an anomaly in the communication is present or not.

In this context, the multicore processor or microcontroller is specifically used within a vehicle, and it is configured to monitor communication between at least two of the plurality of cores. This means that the multicore processor or microcontroller is designed to detect and prevent anomalies in the communication between the different cores, which could potentially cause problems with the vehicle's systems.

The expression “plurality of cores” may be understood as a group or collection of two or more cores in a multicore processor or multicore microcontroller. Each core is a separate processing unit that can execute instructions independently of other cores in the system. The number of cores in a system can vary widely, from a few to hundreds of cores, depending on the application and design of the system.

In this context, the multicore processor or multicore microcontroller is configured to monitor a communication between at least two of the plurality of cores. This means that the system is capable of detecting and analyzing the communication between two or more specific cores within the system. The monitoring of the communication is performed based on a monitoring result, which indicates whether an anomaly is present in the communication or not.

The communication may involve the transmission of data from one core to another core, and/or the reception of data by one core from another core. The communication may also involve the exchange of control information, such as commands or requests, between the cores.

In the present invention, the communication is monitored to detect any anomalies or deviations from the expected behavior of the communication. The anomalies or deviations may be detected through various means, such as monitoring the data being transmitted or received, monitoring the timing of the communication, or monitoring the behavior of the cores involved in the communication.

Once an anomaly or deviation is detected, the decision is made whether the anomaly is present or not. This decision is based on a predefined or definable set of rules, which may be specific to the particular system or application in which the present invention is used.

It should be noted that the communication in the present invention may be based on a variety of protocols or standards, such as TCP/IP, UDP, HTTP, or CAN bus, and may involve the transmission of data in various formats, such as ASCII, binary, or JSON. Additionally, the communication may be encrypted and/or authenticated to ensure the security and integrity of the data being transmitted.

The expression “at least two of the plurality of cores” may be understood as referring to a communication between at least two of the multiple processing cores present within the multicore processor or multicore microcontroller. This communication may be used to transmit data or instructions between the multiple cores, and the expression “at least two” indicates that the communication may involve any combination of two or more of the available cores.

The expression “monitoring result” may be understood as the output or result of the process of monitoring a communication between at least two of the plurality of cores in a multicore processor or multicore microcontroller, particularly within a vehicle. The monitoring result may include any information or data that is obtained or generated during the monitoring process, such as error codes, warning signals, log files, or other types of data that indicate the presence of an anomaly in the communication. The monitoring result may also include information about the nature of the anomaly, such as the type of anomaly, the severity of the anomaly, or the impact of the anomaly on the overall system.

In this context, the monitoring result is used to determine whether an anomaly is present in the communication between the at least two of the plurality of cores. This may involve analyzing the monitoring result to identify any patterns or anomalies that may indicate a security threat or a potential failure in the system. The monitoring result may be analyzed using various techniques, such as statistical analysis, machine learning algorithms, or other methods that are conventional in the related art.

It is important to note that the monitoring result may be generated by various means, including software, hardware, or a combination of both. The monitoring result may also be stored in various forms, such as in a log file, in memory, or on a storage medium. The monitoring result may be used to generate alerts, warnings, or other types of notifications that inform the user of the presence of an anomaly in the communication.

The expression “anomaly in the communication” may be understood as a deviation or an irregularity in the communication between two or more cores of a multicore processor or microcontroller, particularly within a vehicle. This deviation or irregularity can be caused by various factors, such as a malfunction in one of the cores, a hardware or software error, an attack or an unauthorized access to the communication channel, or a problem with the communication protocol or data format. The anomaly can lead to a failure or malfunction of the system, which can have serious consequences, such as a loss of data, a security breach, or even a physical damage to the vehicle.

In order to detect and mitigate the anomalies in the communication, the multicore processor or microcontroller may be configured to monitor the communication between the cores and compare the data being transmitted with a predefined or definable set of rules. If the anomaly is detected, the system may take appropriate actions, such as stopping the communication, logging the incident, or warning the user.

It is important to note that the expression “anomaly in the communication” is a broad term and can include various types of irregularities, such as data corruption, data loss, data tampering, or unauthorized access. The specific type of anomaly can be determined by analyzing the monitoring results and the context in which the anomaly occurred.

In another aspect of the present invention, a computer-readable storage medium may be provided comprising instructions which, when executed by a computer, cause the computer to carry out the steps of the method according to the present invention.

The expression “computer-readable storage medium” may be understood as a storage device or medium that can be read or accessed by a computer or other electronic device. This medium may be in a physical form, such as a hard drive, flash drive, or CD-ROM, or it may be in a virtual form, such as a memory or database. The computer-readable storage medium may be used to store data, programs, or other information that can be accessed and processed by a computer or other electronic device.

The expression “steps” may be understood as the specific operations or actions that are performed by the method of the present invention, in order to achieve the desired outcome. In this context, the steps may include the following:
1. Receiving data between at least two of the plurality of cores.
2. Monitoring the communication between the at least two of the plurality of cores to detect any anomalies.
3. Deciding whether an anomaly is present or not based on the monitoring result.
4. If an anomaly is present, storing the anomaly in a log file and/or outputting a warning signal to a user and/or stopping the communication.
5. If no anomaly is present, continuing the communication between the at least two of the plurality of cores.

It is to be understood that the above-mentioned steps may be performed in any suitable order, and that not all of the steps may be necessary in every implementation of the method. Furthermore, the steps may be combined or omitted based on the specific requirements of the implementation.

Further advantages, features and details of the present invention will be apparent from the following description, in which embodiments of the present invention are described in detail with reference to the figures. In this context, the features disclosed herein may each be essential to the present invention individually or in any combination.

### BRIEF DESCRIPTION OF THE DRAWINGS

FIG. 1 shows a method, computer program, a storage medium and apparatus according to example embodiments of the present invention.

FIG. 2 shows a data format according to an example embodiment of the present invention.

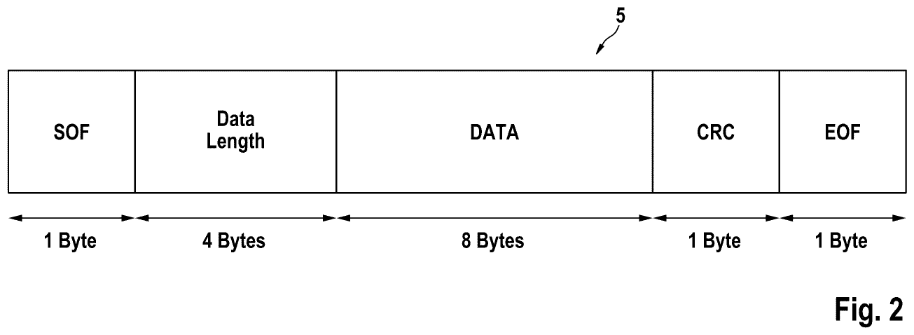

FIG. 3 shows a method according to a further example embodiment of the present invention.

### DETAILED DESCRIPTION OF EXAMPLE EMBODIMENTS

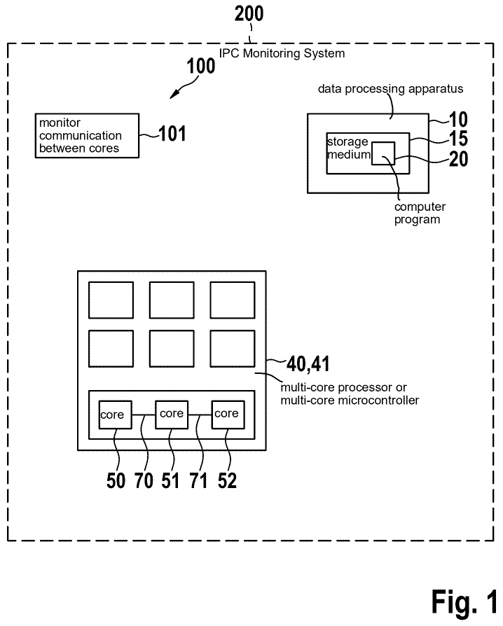

FIG. 1 shows a schematic representation of a method 100, a computer program 20, a storage medium 15, a data processing apparatus 10 and a multicore processor 40 or multicore microcontroller 41 according to embodiments of the present invention, whereby these elements essentially form an Inter-Processor Communication (IPC) Monitoring System 200. The method 100 according to an embodiment of the present invention may comprise a first step 101, wherein the communication 70, 71 between at least two of the plurality of cores 50, 51, 52 is monitored 101.

FIG. 1 illustrates the Inter-Processor Communication (IPC) Monitoring System 200 designed to address the need for secure data exchange between different cores 50, 51, 52 in a multicore processor 40 deployed in modern vehicles. With the ongoing transition in the automotive industry towards centralized architectures and the use of System on Chip (SoC) solutions, the need for efficient and secure inter-processor communication has become crucial.

The system 200 in this embodiment is designed as a heterogeneous multicore processor 40 (Asymmetric Multi Processing) and consists of multiple cores 50, 51, 52. The following description is also substantially applicable to a multicore microcontroller 41. These cores 50, 51, 52 are responsible for executing various tasks and processing data within the SoC system.

To facilitate data exchange between the processor cores 50, 51, 52, the system 200 utilizes Inter-Processor Communication (IPC) mechanisms such as sockets, pipes, or shared memory. However, the existing IPC communication channels 70, 71 lack security measures, making them vulnerable to potential threats and unauthorized access.

The IPC Monitoring System 200 addresses this issue by monitoring continuously the data exchange between the processor cores 50, 51, 52, detecting any suspicious or unauthorized activities and therefore ensures the security and integrity of the IPC communication channels 70, 71.

In one embodiment, the system 200 can employ advanced security algorithms and protocols to encrypt and authenticate the data transmitted through the IPC channels 70, 71, providing a secure communication environment. Additionally, the system 200 logs and analyses the communication patterns, allowing for real-time threat detection and response. The method 100 may operate on a Linux core as a parallel thread to monitor and analyze the communication 70,71.

By implementing the IPC Monitoring System 200, the automotive industry can enhance the security and reliability of inter-processor communication 70, 71 in multicore processors 40, ensuring the protection of sensitive data and mitigating potential security risks.

The IPC Monitoring System 200 can also be considered as a host-based Intrusion Detection System 200 (IDS). Such a host-based Intrusion Detection System 200 focuses on anomaly-based detection to identify abnormal activities based on the behaviour of Inter-Process Communication 70, 71. In another embodiment (not shown here), the IDS 200 consists of multiple components, including the IPC communication module, anomaly detection engine, acceptance criteria module, response module, and threat information logging module.

The IPC communication module utilizes a custom frame format 5, developed specifically for the host-based IDS 200, to transfer messages between different processes on the host system. Unlike user application-level protocols like CAN, the IPC frame format 5 is not predefined, allowing for flexibility and customization. In this embodiment, the Remote messaging Protocol (RPMSG) is employed as the IPC mechanism, enabling the transfer of up to 256 bytes of maximum data.

The anomaly detection engine analyses the IPC communication patterns and behaviour to detect any abnormal activities that deviate from predefined rule sets. When an anomaly is detected, the acceptance criteria module evaluates the severity and relevance of the detected anomaly based on the defined rule sets. If the anomaly fails the acceptance criteria, the response module generates appropriate responses to mitigate the threat. Additionally, the threat information logging module records detailed information about the detected anomaly, including timestamps, source and destination processes, and the nature of the anomaly.

Overall, the architecture of the proposed host-based IDS 200 provides an effective and customizable solution for detecting and responding to abnormal activities in IPC communication 70, 71, enhancing the security of the host system.

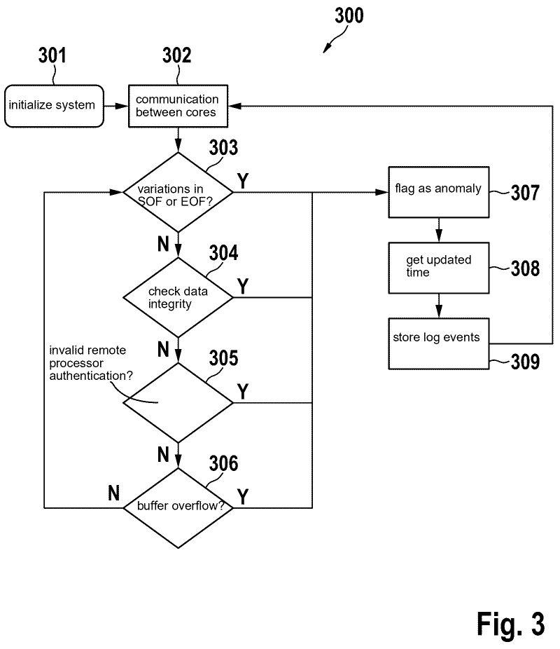

FIG. 3 illustrates an anomaly detection method 300, particularly implemented in software. The method 300 includes several steps to detect different types of anomalies in the system. In a first step 301, the system 200 is initialized. After that, in a second step 302 communication 70, 71 between at least two of the plurality of cores 50, 51, 52 takes place. In other words, data is being sent and/or received via the communication channel 70, 71. In a further step 303, a frame tampering detection takes place. The software detects frame tampering by analysing the custom IPC frame 5 received from different cores 50, 51, 52.

It checks for variations in the Start of Frame (SOF) or End of Frame (EOF) values, indicating potential tampering. If a frame tampering attack is detected (Y), it is captured and flagged as an anomaly in a step 307. If there is no frame tampering attack detected (N), a step 304 follows, where a data integrity check takes place. The software performs a data integrity check on the modified data received from a potential attacker. It uses an 8-bit CRC check to validate the integrity of the data. If the CRC check fails (Y), indicating data modification by an attacker, it is flagged as an anomaly in the step 307. If the CRC check does not fail (N), a step 305 follows, where an invalid remote processor authentication detection takes place. The software monitors attempts to establish communication with processor cores that are not running in the system. If such attempts are detected (Y), indicating invalid remote processor authentication, they are captured and flagged as an anomaly in the step 307. If no such attempts are detected (N), a step 306 follows, where a buffer overflow detection takes place. The software checks the data size set during command line execution.

It performs a boundary check to ensure that the data size does not exceed the allocated buffer size. If a buffer overflow attack is detected (Y), where the data size fails the boundary check, it is captured and flagged as an anomaly in the step 307. If nu such buffer overflow attack is detected (N), the step 303 is repeated. The steps 303 to 306 may be performed repeatedly and/or interchanged with one another in sequence.

In case an anomaly is detected and flagged in step 307, a step 308 can follow, where the system 200 gets an updated time. After that, another step 309 may follow, in which log events are stored, particularly in a JSON file, with specific metadata such as the type of anomaly, occurrence counter, and timestamp. This information can then be fed back in the method 300.

A table with a set of rules illustrating another embodiment of the method 100, 300 for anomaly detection in an IPC system 200 is shown below. The system 200 can also at least partially seen as a, particularly virtual, sensor system that detects anomalies in a communication channel 70, 71 within at least one multicore processor 40 or multicore microcontroller 41. The sensor system is based on a state machine design and utilizes a set of predefined attack events. The attack events are defined in an enum and assigned a constant value, as shown in the following format:

```
typedef enum {
  BUFFER_OVERFLOW_ATTACK = 1,
  INVALID_PORT_ADDRESS_ATTACK,
  TAMPERING_ATTACK_SOF_EOF,
  TAMPERING_ATTACK_DATA,
  FLOODING_ATTACK
} ATTACKS;
```

The IPC sensor system operates using a variable application state that is event-driven. The application state is set to the next state after performing the current state, following a switch case implementation. This approach allows the application to have separate functionalities based on different states, making it scalable for the implementation of additional security events in the future.

To detect anomalies, each state is verified against accepted behaviour using defined rule sets, as shown in the table below. Any anomalies detected are stored in JSON format, which provides ease of readability for humans compared to XML. Additionally, the JSON format supports retrieving values for debugging purposes.

| | |
|---|---|
| Frame Tampering | The anomaly should be generated if Start |
| | Of Frame does not match Ox23 and End Of |
| | Frame doesn't match 0x24. |
| Error Detection | The anomaly should be generated if CRC |
| | Value is modified. |
| Port | The anomaly should be generated if the |
| Authentication | port Value does not match 2. |
| Buffer Overflow | The anomaly should be generated if data |
| | Size fails at boundary check i.e. 15 |
| | bytes. |
| Flooding Attack | The anomaly should be generated if there |
| | are more than one messages receiving in |
| | 20 μs. |

An overview of the communication in an IPC system according to a further embodiment of the present invention could be as follows: An application running on a processor core 50 writes data, along with the port address and name of the remote core 51 into shared memory accessible to all processor cores 50, 51, 52.

An IPC driver writes control messages, such as a shared memory ID, to a mailbox memory map register, which generates an interrupt on the remote core processor. Upon receiving an interrupt signal, an interrupt controller on the remote core 51 calls an interrupt service routine (ISR) of the destination core 50.

The ISR reads the shared memory ID to check if there is any data available on the specific shared memory. If data is available, the remote core 51 reads the data from the shared memory and transfers it to the destination core 50 application.

To avoid message uncertainty caused by overwriting of messages, the shared memory should not be assigned to multiple source and destination cores 50, 51, 52.

1-12. (canceled)

13. A method for determining whether in a communication channel within at least one multicore processor or multicore microcontroller within a vehicle, an anomaly is present, the at least one multicore processor or multicore microcontroller includes a plurality of cores, the method comprising the following steps:
monitoring a communication between at least two of the plurality of cores; and
based on a monitoring result, deciding whether the anomaly is present or not.

14. The method according to claim 13, wherein the monitoring of the communication including at least one of the following steps:
monitoring whether at least one frame of the data being sent between the at least two of the plurality of cores was tampered;
monitoring whether a buffer overflow is present;
monitoring whether a port scanning attack is present;
monitoring whether an invalid remote processor authentication is present;
monitoring whether data being sent between the at least two of the plurality of cores was modified by checking a cyclic check sum value.

15. The method according to claim 13, wherein the decision whether the anomaly is present or not is based on a predefined or definable set of rules.

16. The method according to claim 13, wherein the communication between the at least two of the plurality of cores is based on data being sent between the at least two of the plurality of cores, wherein the data includes a predefined or definable data format.

17. The method according to claim 16, wherein the data format includes a start of frame and/or a data length and/or data and/or a cyclic check sum value and/or an end of frame.

18. The method according to claim 13, wherein data being sent in the communication between the at least two of the plurality of cores is encrypted before sending by a first of the at least two of the plurality of cores and decrypted after receiving by a second of the at least two of the plurality of cores.

19. The method according to claim 13, further comprising using a cryptographic checksum over a payload of data being sent in the communication between the at least two of the plurality of cores and monitoring data integrity after transmission of the data.

20. The method according to claim 13, further comprising storing the anomaly in a log file and/or outputting a warning signal to a user and/or stopping the communication when the anomaly is present.

21. A data processing apparatus configured to determine whether in a communication channel within at least one multicore processor or multicore microcontroller within a vehicle, an anomaly is present, the at least one multicore processor or multicore microcontroller includes a plurality of cores, the data processor apparatus configured to:
monitor a communication between at least two of the plurality of cores; and
based on a monitoring result, decide whether the anomaly is present or not.

22. A multicore processor or multicore microcontroller within a vehicle, wherein the multicore processor or multicore microcontroller comprises:
a plurality of cores, wherein the multicore processor or multicore microcontroller is configured to that a communication between at least two of the plurality of cores is monitored, wherein based on a monitoring result, it is decided whether an anomaly in the communication is present or not.

23. A non-transitory computer-readable storage medium on which are stored instructions for determining whether in a communication channel within at least one multicore processor or multicore microcontroller within a vehicle, an anomaly is present, the at least one multicore processor or multicore microcontroller includes a plurality of cores, the instructions, when executed by a computer, causing the computer to perform the following steps:
monitoring a communication between at least two of the plurality of cores; and
based on a monitoring result, deciding whether the anomaly is present or not.
